(19) United States
(12) Patent Application Publication
(10) Pub. No.: US 2019/0257008 A1
(43) Pub. Date: Aug. 22, 2019

(54) Warning indicator used for tie down straps-slings-slings

(71) Applicants: Chris Little, Lake Elsinore, CA (US); Josh Little, Lake Elsinore, CA (US)

(72) Inventors: Chris Little, Lake Elsinore, CA (US); Josh Little, Lake Elsinore, CA (US)

(21) Appl. No.: 15/898,605

(22) Filed: Feb. 18, 2018

(51) Int. Cl. D03D 15/00; D03D 1/00

(52) U.S. Cl. CPC D03D 15/0033; B60P 7/0823; D03D 2700/0174; D03D 1/00

(57) ABSTRACT

A webbing formed of synthetic yams having an indicator for indicating exposure to abrasion which results in strength loss of said synthetic yams. The strength toss indicator comprises a strip extending the length of the webbing placed between two layers of additional webbing. As the webbing is abraded the top layer of webbing is worn down exposing the middle layer of colored yarn acting as the warning indicator. Correlated to the rate of loss of tensile strength of said synthetic yarns due to abrasion.

### FIELD OF THE INVENTION

The present invention relates to a webbing formed of synthetic yams having an indicator for measuring abrasion which results in strength loss of the synthetic yarns, and more particularly, to the colored indicator yarn located in between to layers of outer webbing, which is correlated to the rate of loss of tensile strength of the synthetic yams due to abrasion and wear and tear to indicate the condition of the webbing.

### BACKGROUND OF THE INVENTION

The prior art is replete with various inventions directed to the methods of providing abrasion indictors However. none of these inventions are directed to said method of using colored yarns to become exposed at predetermined rate corresponding to the ware of the product. Notably, many synthetic yams are subject to abrasion breakdown in the presence of use. The longer the exposure, the greater the loss of tensile strength in the synthetic yarns, such as nylon. Nothing in the prior art uses indicator yarns in the method to correlate the abrasion of synthetic yarns to indicate loss of tensile strength in the synthetic yams as a result of abrasion.

Accordingly, it is an object of the present invention to provide a ware indicator for webbings made of synthetic yarns which measure abrasion and alert the user to when it is time to remove the webbing from service-.

### SUMMARY OF THE INVENTION

The above objectives are accomplished according to the present invention by providing a webbing formed of synthetic yarns having an indicator for indicating abrasion to which results in strength loss of said synthetic yarns. In a preferred embodiment, the strength loss indicator comprises internal colored yams extending the entire length of the webbing. Advantageously, the exposure or the colored yarns at a rate which may be correlated to the rate of loss of tensile strength of said synthetic yarns also due to abrasion to indicate the condition of the webbing. Preferably, the webbing comprises fabrics which are one of woven, knitted, and non-woven. The fabrics are formed of synthetic yarns made of a thermoplastic polymer. In a preferred embodiment, the webbing comprises one of a tie-down, and a sling web. Other fabrics for other uses may also find the strength loss indicator useful.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1, figure, is a cutaway perspective view of webbing according to the invention.

FIG. 2, Figure that is shown illustrates at side view of the said method of weaving yarns with colored indictor yarns used.

FIG. 3, this represents the abrasion that occurs over time and use.

FIG. 4, this represents a side view of abrasion to webbing that happens over time and use. Depiction of this abrasion that exposes the secondary indicator yarns noting the need to replace the webbing.

FIG. 5, FIG. 5 is an image of the finished product exposing the colored ware indicator yam.

FIG. 6, this fig. shows the opposite side of the webbing that is not exposed to the abrasion.

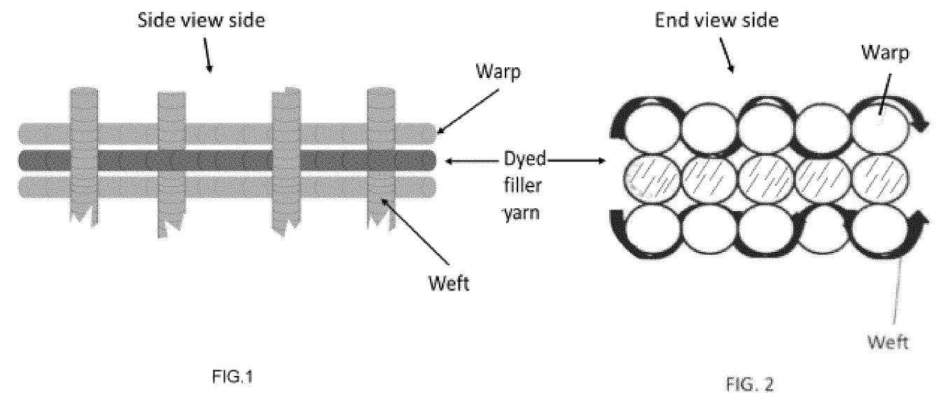

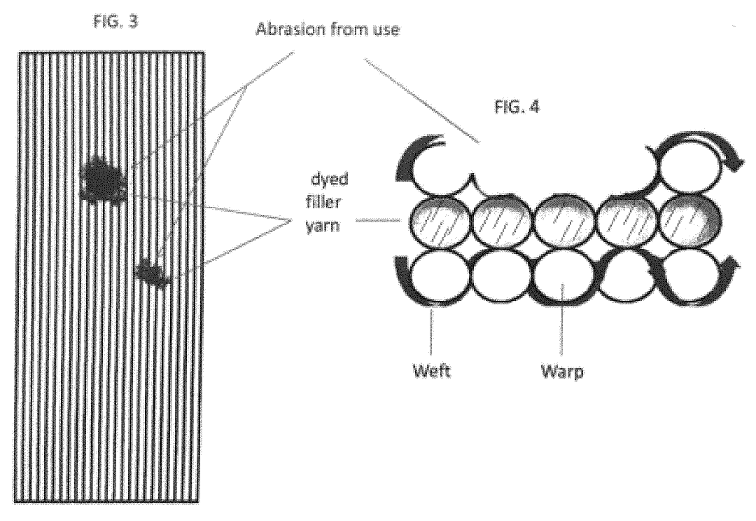

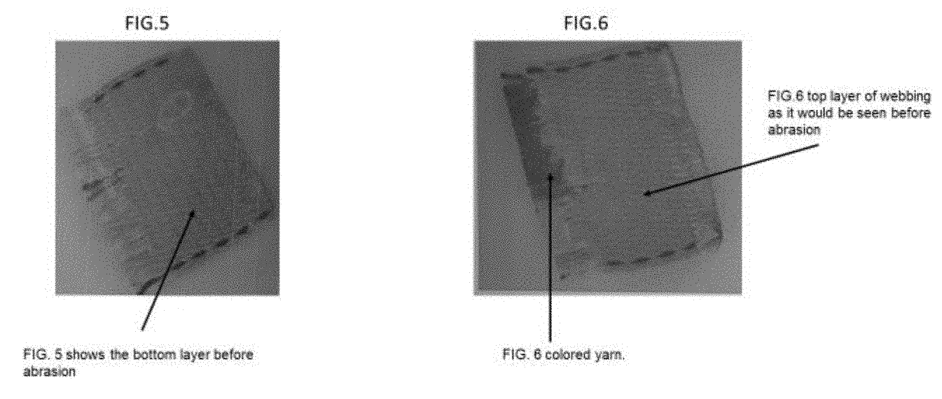

### DESCRIPTION OF A PREFERRED EMBODIMENT

With reference to the drawing, the invention will now be described in more detail. FIG. 1 shows a section of webbing, designated generally as A, woven of synthetic yarns. It is to be understood that the webbing could be knitted or a non-woven. As shown, the webbing is a multi-layer fabric, however, single webbings also find utility with the indicator of the invention.

By way of example, the webbing is of the type commonly used to produce items such as a tie-down, and a sling web. It is well known that exposure to abrasion has significant breakdowns between the molecular bonds in the majority of commonly used synthetic yarns, such as nylon, polyester and Kevlar. Previously, there was no true way of measuring the abrasion damage or breakdown on webbings made of such materials. This can result in the dangerous overuse of products and particularly such products as industrial fabrics which may have lost the ability to support the original and intended lands due to exposure to abrasion.

The present invention solves this problem by incorporating a strength loss indicator with webbing A for indicating the time of exposure to abrasion which results in strength loss of the synthetic yarns. In a preferred embodiment, the strength loss indicator comprises a set of colored yarns the indicator yarns may be arranged alongside each other

Preferably. the color of the yarn used as an indicator is of a different shade then the color of the outerlayers of woven yams giving it contrast the exposures of these colored yams are well known to those skied in the art, which provides the user a visual indication it's time to replace the webbing.

Advantageously, this ability to visually see the colored yarns correlated to the rate tensile strength loss of synthetic yams due to abrasion exposure.

For example, a strip including the colored indicator yarns can be incorporated into the webbing of a safety strap made of polyester. After approximately 1000 to 2000 cycles of abrasion exposure, the tensile strength of the synthetic yams and consequently the webbing will be reduced by approximately 40 percent. At this point the strap is considered no longer safe for use. The colored abrasion indictor yarns incorporated in this particular embodiment is manufactured to maintain its durability ability for approximately 1000 to 2000 cycles of abrasion, which corresponds with a loss of tensile strength of the said webbing of about approximately 40 percent. The properties of the colored indictor yams material in the strip described above can be adjusted and varied accordingly to indicate any desired amount of abrasion exposure for a given percentage of tensile strength loss for any specific synthetic yam or combination of synthetic yarns.

Preferably, the layer is formed of at least one synthetic yarn which includes the colored yams and is incorporated along with the other synthetic yarns during formation of the webbing. As earlier described, a strip, as indicated by reference number 1 and 2 may comprise a single polyester yarn coated with the dyeing material which is woven into the webbing

As earlier stated, the webbing is formed by one of woven, knitted, and non-woven synthetic yarns made of a thermoplastic polymer in which the tensile strength degrades when exposed to abrasion. The webbing may be formed in multi-layers depending upon the desired use and strength requirements. Examples of synthetic thermoplastic polymers likely to be used in form the webbing include polyamides, polyesters, polypropylene, polyethylene, polyacrylates, polycarbonates, polycarbonate, polyacrylonitrile, polyvinyl chloride, polymethacrylates, polystyrene, polyurethane, acrylate resins, halogenated polymers, and mixtures and blends thereof. The composition of the indicator yams of the strip is adapted to the specific chemistry for the specific thermoplastic polymer used to form the webbing-

While a preferred embodiment of the invention has been described using specific terms. such description is for illustrative purposes only, and it is to be understood that changes and variations may be made without departing from the spirit or scope of the following claims.

1. A webbing formed of synthetic yarns which lose strength due to exposure to abrasion, and wearing out said webbing including an indicator comprising:
a strip extending inside between at least a portion of said webbing;
Said strip including colored yarns which produces an indication, said webbing material is losing its ability to maintain is desired breaking strength whereby, said loss of outer webbing due to abrasion or wear and tear from use, correlated to use of the said webbing.

2- The webbing of claim 1 wherein said webbing comprises one of woven, knitted, and non-woven synthetic yarns.

3. The webbing of claim 1 wherein said synthetic and non-synthetic yarns can be comprised of a thermoplastic polymer or any other woven yarns made from natural materials, or nylon

4. The webbing of claim 1 wherein said thermoplastic polymer can be selected from the group consisting of polyamides, polyesters. polypropylene, polyethylene, polyacrylates, polycarbonates, polycyanoethylenes, polyacrylonitrides, polyvinyl chloride, polymethacrylics, polystyrene, polyurethane, acrylate resins, halogenated polymers, and mixtures of natural materials, nylons or and blends thereof.

5- The webbing of claim 1 wherein said webbing comprises one of a tie-down. and a sling web.

6. The webbing of claim 1 wherein said strip comprises at least one synthetic yarn, or nylon and or natural materials which includes said warring yarn material

7. The webbing of claim 1 wherein said strip includes at least one polyester yarn or nylon and or natural materials dyed with said colored material.

8. A method of forming webbing formed of synthetic yarns or nylon and or natural materials which incur strength loss over time due to exposure to abrasion, and wear and tear, with an indicator for determining the degree of said strength of said yarns over time, said method comprising:
Exposure to the colored yarns containing strip represents diminished strength or wear and tear of said yarns.
